(19) United States
(12) Patent Application Publication
(10) Pub. No.: US 2014/0172392 A1
(43) Pub. Date: Jun. 19, 2014

(54) SIMULTANEOUS MAPPING AND REGISTERING THERMAL IMAGES

(71) Applicant: PALO ALTO RESEARCH CENTER INCORPORATED, (US)

(72) Inventors: Craig Eldershaw, Belmont, CA (US); Francisco Eduardo Torres, San Jose, CA (US); Kelly Lee Coupe, San Jose, CA (US)

(73) Assignee: PALO ALTO RESEARCH CENTER INCORPORATED, Palo Alto, CA (US)

(21) Appl. No.: 13/718,280

(22) Filed: Dec. 18, 2012

(51) Int. Cl. G06F 17/50

(52) U.S. Cl. CPC G06F 17/5009
USPC 703/6

(57) ABSTRACT

An apparatus (10) generates a three dimensional (3D) thermal model of the surfaces of or in the building being studied. It includes: a tracking part (24) which determines a location of the apparatus as the apparatus is moved through the building; a range-finding part (18) which measures distances from the apparatus to one or more structures of or in the building as the apparatus is moved through the building; a thermal camera (16) which obtains thermal images of one or more structures of or in the building as the apparatus is moved through the building; and a processor (20) which generates an intermediate 3D model of at least one of the building and its contents based on locations of the apparatus obtained from the tracking part and measured distances obtained from the range-finding part, and maps thermal images obtained from the camera to the intermediate 3D model to generate the 3D thermal model of at least one of the building and its contents.

### BACKGROUND

The present inventive subject matter relates generally to the art of thermal imaging. Particular but not exclusive relevance is found in connection with generating three-dimensional (3D) thermal models of buildings and the like. Accordingly, the present specification makes specific reference thereto. It is to be appreciated however that aspects of the present inventive subject matter are also equally amenable to other like applications.

In the interest of increasing the energy efficiency of buildings and/or other like structures, two-dimensional (2D) thermal and/or infrared (IR) imaging has been used to identify hot and/or cold spots on a building's surfaces and/or structures which indicate possible locations of insufficient insulation and/or thermal leeks. For example, hot and/or cold spots may appear on any of a number of individual 2D thermal and/or IR images taken of a building's walls, ceilings, floors, roofs, surfaces of structures within buildings, etc.

Commonly, the 2D images are acquired with a handheld thermal and/or IR camera. It is typically impractical however to take and/or store images with such a handheld camera in a manner that completely canvasses all of the building's surfaces and/or structures. Accordingly, in some cases, only those images that a user deems to be sufficiently anomalous (i.e., those that show a sufficiently hot or cold spot) may be saved. Of course, this results in piecemeal measurement and/or recording of the building without any registration of the 2D thermal images to an overall map of the building. While perhaps some manually entered annotations and/or notes may indicate roughly where each individual 2D thermal image was obtained, they do not precisely and/or accurately identify where the 2D images reside, either with respect to an overall model and/or map of the entire building or even relative to one another.

Such prior 2D thermal imaging approaches generally do not provide a sufficiently precise, complete and/or accurate 3D thermal model of a building, e.g., which can be used for holistic building analysis. For example, those anomalies that are theoretically detectable, but are generally only recognizable over a larger scale, may go unnoticed in the piecemeal approach described above. In particular, for example, a poorly insulated HVAC (Heating, Ventilation and Air Conditioning) return duct in a ceiling may only have very slight indications in a single 2D thermal image of a limited portion of the ceiling. Indeed, in such a case, the anomaly may appear fuzzy, with a low aspect-ratio. Conversely, visualization of the entire ceiling at once may clearly show a high aspect-ratio line extending a relatively long distance over the ceiling, which indication may be more readily apparent.

Accordingly, a new and/or improved method, system and/or apparatus for thermal imaging is disclosed which addresses the above-referenced problem(s) and/or others.

### SUMMARY

This summary is provided to introduce concepts related to the present inventive subject matter. This summary is not intended to identify essential features of the claimed subject matter nor is it intended for use in determining or limiting the scope of the claimed subject matter.

In accordance with one embodiment, an apparatus is provided which generates a three dimensional (3D) thermal model of a building being studied. It includes: a tracking part which determines a location of the apparatus as the apparatus is moved through the building; a range-finding part which measures distances from the apparatus to one or more structures of or in the building as the apparatus is moved through the building; a thermal camera which obtains thermal images of one or more structures of or in the building as the apparatus is moved through the building; and a processor which generates an intermediate 3D model of at least one of the building and its contents based on locations of the apparatus obtained from the tracking part and measured distances obtained from the range-finding part, and maps thermal images obtained from the camera to the intermediate 3D model to generate a 3D thermal model of at least one of the building and its contents.

In accordance with another embodiment, a device is provided for generating a three dimensional (3D) thermal model of a building being studied. The device includes: a means for tracking a location of the device as the device is moved through the building; a means for measuring distances to one or more structures of or in the building as the device is moved through the building; a means for obtaining thermal images of one or more structures of or in the building as the device is moved through the building; and processing means for generating an intermediate 3D model of the building based on locations of the device obtained by the tracking means and measured distances obtained by the measurement means, and mapping thermal images obtained by the imaging means to the intermediate 3D model to generate a 3D thermal model of at least one of the building and its contents.

In accordance with yet another embodiment, a method for generating a three dimensional (3D) thermal model of a building being studied includes: measuring distances to one or more structures of or in the building; obtaining thermal images of one or more structures of or in the building; generating an intermediate 3D model of at least one of the building and it contents based on the measured distances; and mapping the obtained thermal images to the intermediate 3D model to generate a 3D thermal model of at least one of the building and its contents.

Numerous advantages and benefits of the inventive subject matter disclosed herein will become apparent to those of ordinary skill in the art upon reading and understanding the present specification.

### BRIEF DESCRIPTION OF THE DRAWING(S)

The following detailed description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing an exemplary camera system suitable for practicing aspect of the present inventive subject matter.

FIG. 2 is a diagrammatic illustration showing the camera system of FIG. 1 in one exemplary environment suitable for its operation.

FIG. 3 is a flow chart illustrating an exemplary process for generating a 3D thermal model of a building in accordance with aspects of the present inventive subject matter.

### DETAILED DESCRIPTION OF THE EMBODIMENT(S)

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

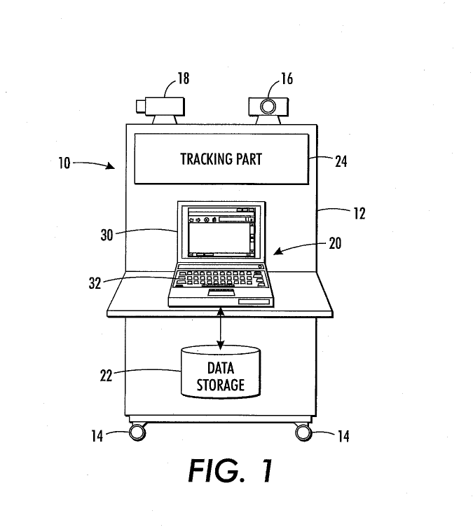

With reference now to FIG. 1, there is shown a mobile and/or portable camera system 10. As shown, the system 10 is provided on a cart 12 or the like equipped with wheels 14 or the like that facilitate movement of the cart 12, e.g., through the rooms and/or around one or more floors or levels of a building or other like structure being studied and/or recorded. The system 10 also includes a thermal camera 16 and a rangefinder or range-finding part 18. Suitably, the camera 16 is an IR camera. In practice, the camera 16 may be a digital camera and may be either a still picture camera or a video camera. Optionally, the camera 16 and/or the range-finding part 18 may be mounted to the cart 12 so as to be able to tilt, pan and/or otherwise point in an array of different directions, e.g., to view various building structures (i.e., walls, floors, ceilings, etc.) on different sides of the cart 12.

In the illustrated embodiment, the system 10 is provisioned on a cart 12. However, it is to be appreciated that optionally the system 10 may be provisioned on a backpack or other like wearable device or it may be a handheld or otherwise portable apparatus that does not rest on the floor or ground, e.g., in which case the wheels 14 may be optionally omitted.

The range-finding part 18 optionally includes a LIDAR (Light Detection and Ranging) module and/or a SLAM (Simultaneous Localization and Mapping) module and/or other suitable sensors and/or detectors for measuring distances between the cart 12 and building structures (e.g., such as walls, floors, ceiling, etc.) and/or for locating the cart 12 and/or other objects and/or structures in the building being studied. An on-board computer 20 and/or other suitable processor collects, records and/or processes the measurements, images, data and/or other information obtained and/or generated by the various components, instruments, parts and/or modules of the system 10.

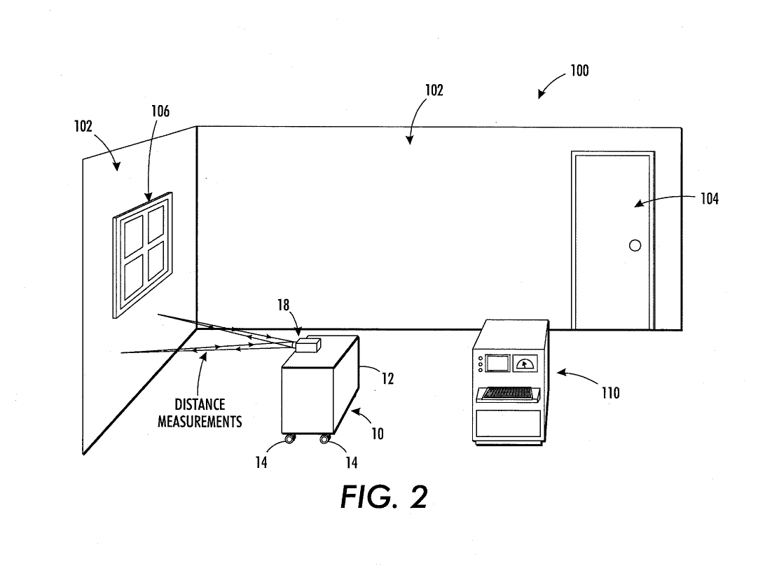

FIG. 2 illustrates the system 10 with optional cart 12 in an exemplary environment in which it may operate. As shown, a building 100 (or portion thereof) being studied with the system 10 has one or more walls 102, e.g., including interior and/or exterior walls, and there may be one or more doors 104, windows 106 or the like in any one of the walls 102. Of course, each floor or level of the building may include a floor and a ceiling as well. Additionally, the building 100 may have various items, such as equipment, appliances, cabinets, furnishings and/or other contents 110 housed therein. As shown, the ranging-finding part 18 is measuring multiple distances to a wall 102 of the building 100. Similarly, it is to be appreciated that the camera 16 (as shown in FIG. 1) and the range-finding part 18 and/or other instruments, modules and/or parts of the system 10 view, measure, detect, sense and/or obtain data from and/or images of the other building structures and/or contents as well. Generally, as used herein, the terms building and/or building structures and/or the contents thereof include the walls, floors, ceilings, windows, doors and other parts or structures of and/or contents in the building which are observed, imaged, measured, located and/or otherwise detected by and/or sensed by the camera 16, the range-finding part 18 and/or the other instruments, modules and/or parts of the system 10 to generate either or both of an intermediate 3D model and/or a 3D thermal model as described herein.

Returning attention now to FIG. 1, suitably, the computer 20 and/or processor may be equipped with and/or have access to a memory 22 and/or other suitable data storage device in which various measurements, images, information and/or other data (e.g., obtained, collected and/or generated by the various components, instruments, parts and/or modules of the system 10) are stored. The memory 22 or other storage device may also be used to save any resulting processed data, information and/or generated outputs, e.g., such as a generated intermediate 3D model of the building being studied and/or a final 3D thermal model of the building being studied. In addition, the memory 22 and/or data storage device may also contain software, programming code and/or other suitable instructions which are selectively executed by the computer 20 and/or processor to: i) carry out the various data and/or information processing described herein; and/or ii) control the various components, instruments, parts and/or modules of the system 10 to achieve the operation thereof as described herein.

It is to be appreciated that optionally the data processing may be remotely located and/or conducted off-board. For example, the measurements, images and/or other data obtained by the various instruments and/or other modules or parts of the system 10 may be wirelessly or otherwise transmitted to a remote computer or processor for processing; and/or the measurements, images and/or other data may be saved and/or stored locally and the system 10 may be later connected and/or the data downloaded to a computer or other suitable processor for processing.

In practice, the cart 12 is moved about an interior of a building or other like structure being studied. For example, the cart 12 may be rolled on its wheels 14 down the hallways and/or corridors and/or through the various rooms of a given floor of the building. Suitably, one or more instruments of the range-finding part 18 are used to detect the cart's distance from nearby and/or surrounding walls, ceilings, floors and/or other like structures of and/or contents in the building as the cart 12 is being moved about a given floor of the building. Suitably, the cart 12 may also be equipped with a tracking part 24. Based on data and/or feedback from the tracking part 24, suitably the on-board computer 20 tracks the cart's location and/or position (e.g., relative to its starting point) as the cart 12 is being moved. Optionally, the tracking part 24 may include one or more inertial navigation units, 3D camera, rotary and/or wheel encoders, accelerometers, gyroscopes, and/or other motion-sensing devices, sensors and/or detectors. Optionally, the tracking part 24 may include a GPS (Global Positioning System) receiver or the like which is used to track the cart's location and/or position. Additionally, image or 3D feature tracking may also be employed to track the cart's location and/or position from images obtained by the camera 16 or another 2D camera (not shown).

As the cart 12 is moved, based on the cart's given location at any given time (e.g., as determined from the tracking part 24) and the distance measurements to nearby walls, ceilings, floors and/or other like structures of and/or contents in the building at that given time (e.g., as determined by the range-finding part 18), the on-board computer 20 stiches together and/or otherwise generates a 3D model of the level or floor of the building, including the relevant structures of and/or contents in the building, e.g., such as the walls, floors, ceilings, etc. Suitably, the cart 12 may be moved through and data acquired for all or a plurality of the levels or floors of a given building or other like structure, and accordingly a 3D model may be created and/or generated for the entire building or for all or one or more of the levels or floors so studied and/or recorded.

Additionally, as the cart 12 is moved, the camera 16 also obtains thermal images (i.e., thermograms) of the nearby and/or surrounding building structures and/or contents, e.g., such as the walls, floors, ceilings, etc. Suitably, as the thermal images are obtained by the camera 16, the location of the cart 12 (e.g., determined from the tracking part 24) is noted and correlated or otherwise associated therewith. In this way, the system 10 is aware of and/or otherwise knows the location and/or orientation (i.e., the pose) of the cart 12 and/or the camera 16 when each thermal image was obtained. Having constructed and/or otherwise generated the intermediate 3D model of the building (e.g., as discussed above) and correlated the relative location and/or pose of the cart 12 and/or camera 16 (e.g., determined from the tracking part 24) with each thermal image obtained by the camera 16, the thermal images are mapped, applied and/or warped to their appropriate location in and/or on the intermediate 3D model (e.g., by the computer 20) to generate a 3D thermal model of the building and/or its contents.

Suitably, the intermediate 3D model and/or the 3D thermal model are virtual and/or electronic models. That is to say, the models are actually saved as data, e.g., in the memory 22. The data in this case represents the relative locations of the various structures of and/or contents in the building (e.g., such as the walls, ceilings, floors, etc., which relative locations are measured and/or otherwise determined via the range-finding and/or tracking parts 18 and 24) along with the relative temperatures of and/or temperature gradients existing across those structure and/or contents (e.g., as determined from the thermograms and/or thermal images captured by the camera 16).

As shown, the computer 20 includes a monitor and/or display 30 on which the intermediate and/or thermal 3D models may be selectively output. Optionally, a user interface and/or input device 32 may be provided so that a user may select how the models are visualized on the display 30. For example, the user may select via the interface and/or input device 32 a view angle, cross-section, zoom and/or other viewing options to output the model on the display 30 in a desired fashion. Suitably, the structures of and/or contents in the building (e.g., the floors, walls, ceilings, etc.) are rendered on the display 30 in accordance with the selected view options at their relative locations and at their relative sizes, with the various temperatures and/or temperature gradients of the structures and/or contents indicated by color coding the output rendering. Of course, optionally, the models may be transmitted and/or saved remotely and/or off-board and the display and/or rendering of the models may likewise be conducted remotely and/or off-board.

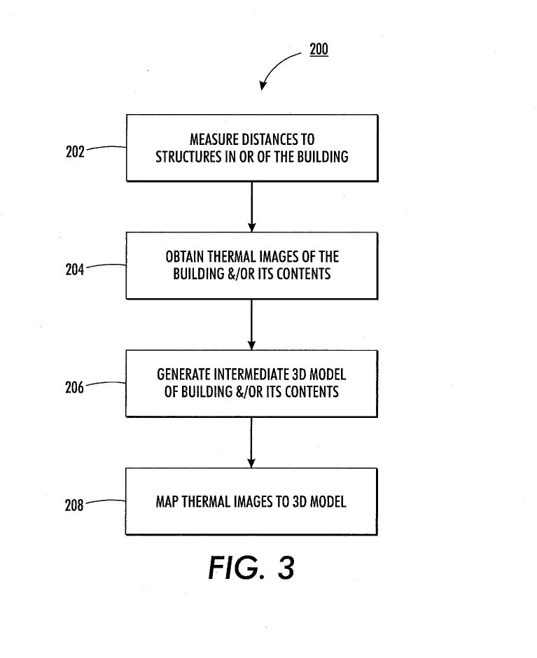

With reference now to FIG. 3, there is shown an exemplary method and/or process 200 for producing a 3D thermal model of a building.

In a first step 202, one or more measurement devices and/or instruments, e.g., such as those described above with respect to the system 10, obtain relative distance measurements to various building structures and/or contents, e.g., such as the floors, walls, ceilings, etc. At step 204, thermal images or thermograms of the various building structures and/or contents are obtained, e.g., via the camera 16. At step 206, the distance measurements are used to construct an intermediate 3D model of the building and/or its contents. Optionally, as discussed above, SLAM and/or LIDAR may be used to generate the intermediate 3D model of the building and/or its contents. Finally, at step 208, the thermal images and/or thermograms are mapped, applied and/or warped to the intermediate 3D module to generate a 3D thermal model of the building and/or its contents.

In one further embodiment, suitably, two or more 3D thermal models of the same building are generated with the system 10 from studies and/or data collected at different points in time. For example, a first study may be conducted with the system 10 prior to some remedial action being taken to improve the energy efficiency of the building (e.g., such as the addition of insulation). Accordingly, from the first study, a first 3D thermal model is generated as described herein. At a later time (e.g., after the remedial action has been taken), a second study of the same building may be conducted with the system 10 and a corresponding second 3D thermal model is generated. Suitably, the computer 20 or other suitable processor compares the first and second models to one another and/or otherwise performs a quantitative analysis and/or evaluation between the plurality of 3D thermal models. For example, a quantitative comparison between the before and after 3D thermal models can demonstrate and/or indicate the effectiveness of the remedial action(s) taken in the interim between the two studies. Of course, in other applications, different studies can be conducted at different times of the day and/or during different seasons and quantitative comparisons between the resulting 3D thermal models can provide information about the relative effects these variable conditions can have on the energy efficiency of the building.

Of course, there may be in practice any number of desired temperature ranges for various buildings and/or portions or contents thereof that are ideally sought in different cases. For example, some buildings or portions thereof or rooms therein may be refrigerated so as to store food or other perishable goods; and in other examples the buildings or portions thereof or rooms therein may be intended for human occupancy; and in still other cases the buildings or portions thereof or rooms therein may house computers or other heat generating equipment that would benefit from a relatively cooler operating environment; and so on. As can be appreciated, in each of the foregoing examples, different target temperature ranges may be desired and depending on the relative exterior ambient and/or surrounding temperatures a certain amount of heating or cooling may be warranted. However, one generally does not wish to waste energy by excessively heating or cooling a space beyond what is desired or by losing heating or cooling through poor insulation. Accordingly, the system 10 allows the generation of a 3D thermal model which allows a user to visualize a complete 3D thermal profile of a building, e.g., to see where in the building its target temperatures are being efficiently met and where they are not being efficiently met. In this way, remedial or corrective actions (e.g., such as increasing or decreasing heating or cooling or improving insulation) can be targeted specifically to those regions or portions of the building which are over- or under-performing with respect to their desired temperature ranges. Consequently, this aids in maximizing the energy efficiency of the building overall while allowing each portion of the building to more closely be maintained in its target temperature range.

In any event, the above elements, components, processes, methods, apparatus and/or systems have been described with respect to particular embodiments. It is to be appreciated, however, that certain modifications and/or alteration are also contemplated.

It is to be appreciated that in connection with the particular exemplary embodiment(s) presented herein certain structural and/or functional features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, analysis, methods, functions, elements and/or components described herein may suitably be implemented via hardware, software, firmware or a combination thereof. For example, the computer 20 may include a processor, e.g., embodied by a computing or other electronic data processing device, that is configured and/or otherwise provisioned to perform one or more of the tasks, steps, processes, analysis, methods and/or functions described herein. For example, the computer 20 or other electronic data processing device employed in the system 10 may be provided, supplied and/or programmed with a suitable listing of code (e.g., such as source code, interpretive code, object code, directly executable code, and so forth) or other like instructions or software or firmware (e.g., such as an application to perform and/or administer the processing and/or image analysis described herein), such that when run and/or executed by the computer or other electronic data processing device one or more of the tasks, steps, processes, analysis, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, analysis, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, analysis, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred and/or other embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. An apparatus which generates a three dimensional (3D) thermal model of a building being studied, said apparatus comprising:
a tracking part which determines a location of the apparatus as the apparatus is moved through the building;
a range-finding part which measures distances from the apparatus to one or more structures of or in the building as the apparatus is moved through the building;
a thermal camera which obtains thermal images of one or more structures of or in the building as the apparatus is moved through the building; and
a processor which generates an intermediate 3D model of at least one of the building and its contents based on locations of the apparatus obtained from the tracking part and measured distances obtained from the range-finding part, and maps thermal images obtained from the camera to the intermediate 3D model to generate a 3D thermal model of at least one of the building and its contents.

2. The apparatus of claim 1, further comprising:
a data storage device in which is stored at least one of apparatus locations determined by the tracking part, measured distances obtained by the range-finding part, thermal images captured by the camera, the intermediate 3D model generated by the processor and the 3D thermal model generated by the processor.

3. The apparatus of claim 1, further comprising:
a cart on which at least one of the tracking part, the range-finding part, the thermal camera, and the processor is mounted.

4. The apparatus of claim 3, further comprising:
one or more wheels on which the cart is mounted to facilitate movement of the cart around the building being studied.

5. The apparatus of claim 1, further comprising:
a display on which the 3D thermal model is selectively output.

6. The apparatus of claim 5, further comprising:
at least one of a user interface and a user input device by which a user selects one or more viewing options that determine how the 3D thermal model is visualized on the display.

7. The apparatus of claim 1, wherein corresponding locations obtained by the tracking part are associated with thermal images obtained by the camera, and thermal images are applied by the processor to the intermediate 3D model in accordance with the locations associated with the respective images.

8. A device for generating a three dimensional (3D) thermal model of a building being studied, said device comprising:
tracking means for tracking a location of the device as the device is moved through the building;
measurement means for measuring distances to one or more structures of or in the building as the device is moved through the building;
imaging means for obtaining thermal images of one or more structures of or in the building as the device is moved through the building; and
processing means for generating an intermediate 3D model of at least one of the building and its contents based on locations of the device obtained by the tracking means and measured distances obtained by the measurement means, and applying thermal images obtained by the imaging means to the intermediate 3D model to generate a 3D thermal model of at least one of the building and its contents.

9. The device of claim 8, further comprising:
data storage means for storing at least one of device locations determined by the tracking means, measured distances obtained by the measurement means, thermal images captured by the imaging means, the intermediate 3D model generated by the processing means and the 3D thermal model generated by the processing means.

10. The device of claim 8, further comprising:
means for facilitating movement of the device around the building being studied.

11. The device of claim 8, further comprising:
display means for selectively displaying the 3D thermal model.

12. The device of claim 11, further comprising:
selecting means for selecting one or more viewing options that determine how the 3D thermal model is visualized on the display means.

13. The device of claims 11, wherein said processing means further performs a quantitative comparison of a plurality of the 3D thermal models generated at different times.

14. A method for generating a three dimensional (3D) thermal model of a building being studied, said method comprising:
(a) measuring distances to one or more structures of or in the building;
(b) obtaining thermal images of one or more structures of or in the building;
(c) generating an intermediate 3D model of at least one of the building and its contents based on the measured distances; and
(d) mapping the obtained thermal images to the intermediate 3D model to generate a 3D thermal model of at least one of the building and its contents.

15. The method of claim 14, wherein the distances are measured and the thermal images are obtained from a reference location.

16. The method of claim 15, further comprising:
moving the reference location through the building such that distances are measured and thermal images are obtained from a plurality of different reference locations.

17. The method of claim 16, further comprising:
tracking the plurality of different reference locations; and
associating the obtained thermal images with the reference locations from which the thermal images were obtained;
wherein the obtained thermal images are mapped to the intermediate 3D model in accordance with their associated reference locations.

18. The method of claim 17, further comprising:
outputting the 3D thermal model on a display.

19. The method of claim 18, further comprising:
rending the 3D thermal model on the display in accordance with viewing options selected by a user that determine how the 3D thermal model is to be visualized.

20. The method of claim 19, further comprising:
(e) repeating steps (a) through (d) to generate a plurality of 3D thermal models at different points in time; and
(f) quantitatively comparing at least two of the plurality of 3D thermal models to one another.
